(19) United States
(12) Patent Application Publication
(10) Pub. No.: US 2009/0063537 A1
(43) Pub. Date: Mar. 5, 2009

(54) METHOD AND APPARATUS FOR GENERATING A USER PROFILE

(75) Inventors: David Bonnefoy-Cudraz, Gilly sur Isere (FR); Makram Bouzid, Palaiseau (FR); Nicolas Lhuillier, Versailles (FR); Kevin C. Mercer, Wantage (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/847,858

(22) Filed: Aug. 30, 2007

(51) Int. Cl. G06F 17/30

(52) U.S. Cl. 707/102; 707/E17.008

(57) ABSTRACT

A method of generating a user profile initially comprises receiving (201, 203) characterising data, and optionally user preferences, for content items. The characterising data describes characteristics, such as content or context characteristics, of each content item. The content items are then clustered (205) into content item clusters in response to characterising data associated with each content item. For each content item cluster, cluster characterising data is determined (207) in response to characterising data and possibly user preferences associated with each content item in the content item cluster. First characterising data is then received (209) for a first content item and a first content item cluster is selected (211) in response to a comparison of the first characterising data and the cluster characterising data of each content item cluster. A user profile is then generated (211) for the first content item in response to first cluster characterising data of the first content item cluster.

### FIELD OF THE INVENTION

The invention relates to a method and apparatus for generating a user profile and in particular, but not exclusively, to generation of a user profile for selecting a suitable associated content item, such as an advert, for a received content item, such as a television programme.

### BACKGROUND OF THE INVENTION

The availability and provision of multimedia and entertainment content has increased substantially in recent years and in order to identify and select the desired content, the user must typically process large amounts of information which can be very cumbersome and impractical. Therefore, personalised content recommendation services and applications are becoming increasingly popular and significant resources have been invested in research into techniques and algorithms that may assist in identifying suitable content.

Also, increasing research is going into targeting content provision to users without requiring explicit selection. Such content provision includes provision of content not directly selected by association with other content selected by a user, such as provision of customised advertisement or additional information content for a selected content item. In particular, significant research and development is focussed on providing customised and targeted advertisement which is particularly suited for the individual user.

However, in order for personalised and user customised content provision to operate efficiently, it is necessary that a reliable user profile is generated for the user.

For example, targeted advertising for television programmes is being developed. Traditionally for television based advertising, the advertisers/advertisement schedulers typically manually select adverts for individual programmes and include them in the broadcast of this programme. Thus, the only targeting consists in trying to match the adverts with the typical characteristics of the typical group of viewers of a specific programme (e.g. adverts for male shaving products are transmitted during a transmission of a football match). The advert selection is based only on time and on the programme being aired, as this is the only context information available to advertisers.

There is currently a lot of work being performed which is focussed on how to provide more accurate targeting of adverts and in particular on how to provide adverts which are relevant to individual viewers rather than the whole group of viewers of a specific programme. Generally, the approaches are based on generating a profile of the viewer and then selecting specific adverts according to this profile. However, a key difficulty is how to obtain reliable information necessary to build this profile.

One approach is to use information of which programmes are being watched by the user. However, consumer devices, such as televisions, are generally a multi-user device where e.g. all members of a family use it. Therefore, a difficulty arises in such multi-user devices as the generation of an accurate individual user profile will require an explicit identification of the active user(s) which are e.g. viewing the programme or providing the user feedback. This is generally impractical and inconvenient and is in particular unsuitable for many consumer devices, such as televisions or Personal Video Recorders (PVRs), where user friendliness and ease of use is of the utmost importance. An option is to merely generate a common user profile which is common for all users of the device. However, such common user profiles tend to be relatively inaccurate and do not sufficiently reflect the characteristics of the individual user. For example, in a typical family, the preferences of an adult will typically be very different from the preferences of e.g. a young child.

Hence, an improved system for generating a user profile would be advantageous and in particular a system allowing increased flexibility, reduced complexity, increased user friendliness/ease of use, reduced resource usage, facilitated implementation, improved accuracy and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a method of generating a user profile, the method comprising: receiving characterising data for a plurality of content items, the characterising data describing characteristics of each content item; clustering the plurality of content items into content item clusters in response to characterising data associated with each content item; for each content item cluster of the content item clusters determining cluster characterising data in response to characterising data associated with each content item in the content item cluster; receiving first characterising data for a first content item; selecting a first content item cluster from the content item clusters in response to a comparison of the first characterising data and the cluster characterising data of each content item cluster; generating a user profile for the first content item in response to first cluster characterising data of the first content item cluster.

The invention may provide improved performance. In particular an improved accuracy of a user profile may be achieved which may specifically reflect individual characteristics of a user without requiring identification of the user. The approach may allow a multi-user device to automatically generate a user profile for an individual user of the group of users using the multi-user device without requiring any identification of individual users during the user profile generation phase or e.g. any user preference data gathering phase.

The invention may provide increased user friendliness/ease of use as the user profile can be automatically generated without any requirement for manual identification of any user. The invention allows the generation of a targeted user profile with reduced complexity and/or may be implemented using reduced computational resource.

The invention may provide improved performance in systems using a user profile. In particular, improved content provision may be provided and e.g. an improved system for providing individualised/targeted adverts may be achieved.

The characterising data may for example be meta-data characterising the associated content item. For example, the characterising data may be content and/or context data and may e.g. include information of the title, genre, content etc of the content item.

The cluster characterising data of a given content item cluster may simply indicate a general preference for the content item cluster. In some embodiments, the cluster user profile may comprise characterising data describing content items of the first content item cluster and/or may include a user preference for different content item characteristics.

The user profile may include indications of characterising data for content items and/or of user preferences for content items. For example, the user profile may include characterising data describing content items of the first content item cluster and/or may include a user preference for different content item characteristics.

According to another aspect of the invention there is provided an apparatus for generating a user profile, the apparatus comprising a processing system including a memory arranged to store one or more sets of programming instructions that control the processing system to: receive characterising data for a plurality of content items, the characterising data describing characteristics of each content item; cluster the plurality of content items into content item clusters in response to characterising data associated with each content item; for each content item cluster of the content item clusters determine cluster characterising data in response to characterising data associated with each content item in the content item cluster; receive first characterising data for a first content item; select a first content item cluster from the content item clusters in response to a comparison of the first characterising data and the cluster characterising data of each content item cluster; generate a user profile for the first content item in response to first cluster characterising data of the first content item cluster.

According to another aspect of the invention there is provided a media arranged to store programming instructions that control a processing system to: receive characterising data for a plurality of content items, the characterising data describing characteristics of each content item; cluster the plurality of content items into content item clusters in response to characterising data associated with each content item; for each content item cluster of the content item clusters determine cluster characterising data in response to characterising data associated with each content item in the content item cluster; receive first characterising data for a first content item; select a first content item cluster from the content item clusters in response to a comparison of the first characterising data and the cluster characterising data of each content item cluster; generate a user profile for the first content item in response to first cluster characterising data of the first content item cluster.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an apparatus for generating a user profile in accordance with some embodiments of the invention; and

FIG. 2 is an illustration of a flowchart for a method of generating a user profile in accordance with some embodiments of the invention.

### DETAILED DESCRIPTION OF SOME EMBODIMENTS OF THE INVENTION

The following description focuses on embodiments of the invention applicable to a system providing targeted advertising for television programmes. However, it will be appreciated that the invention is not limited to this application but may be applied to many other systems, applications and types of content items.

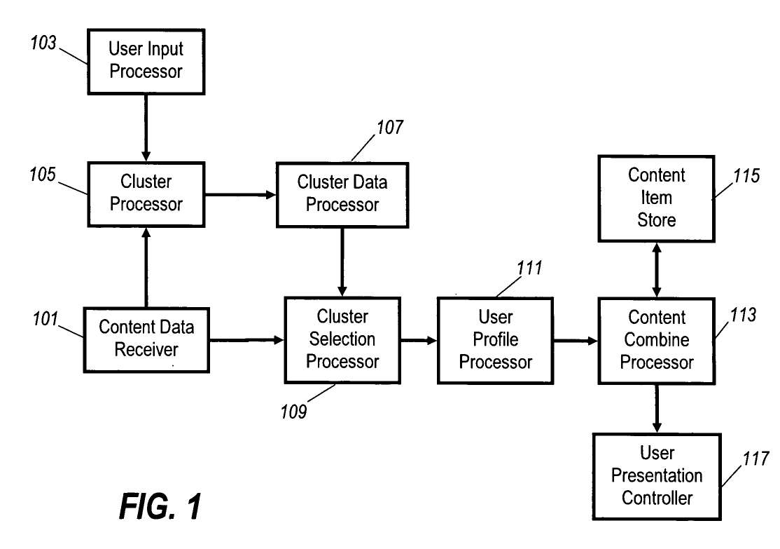

FIG. 1 illustrates an example of an apparatus for generating a user profile in accordance with some embodiments of the invention.

The apparatus is in the specific example a Personal Video Recorder (PVR) which receives, stores and plays back television programmes. The PVR is a multi-user device used by a plurality of users (such as a family) but does not include any means for identifying any individual users.

The PVR comprises a content data receiver 101 which receives characterising data for a plurality of content items. The characterising data describes characteristics of each content item and may specifically include content and context data for the content items. The characterising data may be received independently of the actual content items. For example, the characterising data may be received as an Electronic Programme Guide (EPG) describing the television programmes to be broadcast over, say, the next week.

The apparatus further comprises a user input processor 103 which provides a user interface to the users of the PVR. Specifically, the user input processor 103 can be arranged to receive selections of content items to be recorded or presented to the user(s) as well as user preferences for the content items.

The content data receiver 101 and the user input processor 103 is coupled to a cluster processor 105 which is arranged to cluster the plurality of content items into content item clusters in response to the characterising data which is associated with each content item. Specifically, the cluster processor 105 can cluster the television programmes which have been selected by the users into clusters in response to metadata describing the content and/or metadata describing the context of the content items.

The cluster processor 105 is coupled to a cluster data processor 107 which for each content item cluster determines cluster characterising data in response to characterising data associated with each content item in the content item cluster. Specifically, metadata describing content and/or context and/or user preference data for the cluster as a whole may be determined for each cluster.

The cluster data processor 107 is coupled to a cluster selection processor 109 which is also coupled to the content data receiver 101. When a specific first content item is received (e.g. a content item a user has selected for viewing), the characterising data for the first content item is provided to the cluster selection processor 109. In response, the cluster selection processor 109 proceeds to select a first content item cluster in response to a comparison of the first characterising data and the cluster characterising data of each content item cluster. Specifically, the cluster selection processor 109 can select the first cluster as the cluster which is most similar to the first content item in accordance with a suitable similarity measure.

The cluster selection processor 109 is coupled to a user profile processor 111 which generates a user profile for the first content item in response to the first characterising data. Specifically, the first characterising data may comprise a user preference profile and the user profile processor 111 may set the user profile associated with the first content item to the user preference profile stored for the selected cluster.

The user profile processor 111 is coupled to a content combine processor 113 which is further coupled to a content item store 115. The content item store 115 comprises a number of content items which may be associated with the first content item. For example, the content item store 115 can comprise a number of adverts that may be used with received content items. The content combine processor 113 selects an associated content item for the first content item from the group of stored content items in response to the user profile received from the user profile processor 111. Specifically, the content combine processor 113 may from the stored adverts select an advert particularly suitable for the user profile. The content combine processor 113 then combines the received first content item and the selected associated content item into a single presentation item. Specifically, the retrieved advert may be inserted in an appropriate slot of the received television programme.

The content combine processor 113 is coupled to a user presentation controller 117 which presents the presentation content item to a user. Specifically, the user presentation controller 117 outputs the television programme with the selected targeted advert to a television coupled to the PVR.

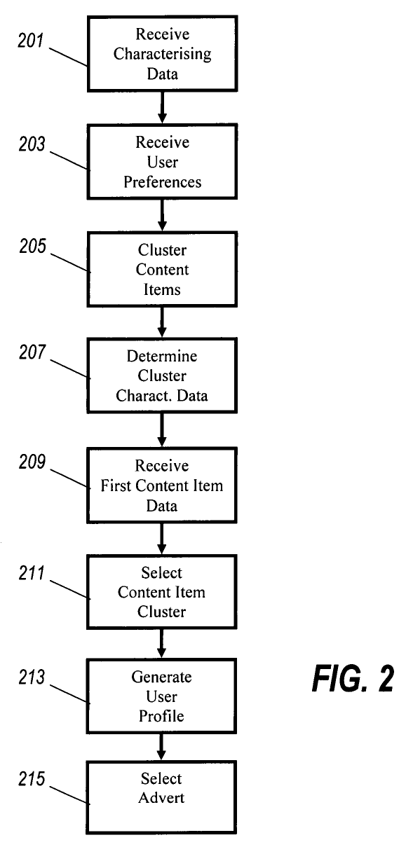

An exemplary operation of the apparatus of FIG. 1 will be described in more detail with reference to FIG. 2 which is an illustration of a flowchart for a method of generating a user profile in accordance with some embodiments of the invention.

The method starts in step 201 wherein the content data receiver 101 receives characterising data for a plurality of content items. In the example, the characterising data is metadata describing the television programmes and may for example include data defining a title, genre, actor(s), director, transmission time, source, time of origination or other information associated with the individual television programme. Thus, the characterising data may provide significant information relating to the content and context of each television programme. In the example, the characterising data is received in an EPG comprising metadata for each television programme being transmitted.

The characterising data for each content item selected by the users is fed to the cluster processor 105 from the content data receiver 101. Specifically, when the cluster processor 105 receives an indication from the user input processor 103 that a television programme is to be viewed or recorded, the cluster processor 105 requests characterising data for the selected television programme from the content data receiver 101. In response, the content data receiver 101 retrieves the appropriate data from the EPG and feeds it to the cluster processor 105.

Over time, the cluster processor 105 will accordingly collect characterising data for a relatively large number of content items/television programmes which have been selected for recording or viewing by the group of users using the PVR.

In the example, step 201 is followed by step 203 wherein the user input processor 103 receives user preferences for some or all of the content items which are selected by the group of users. Thus, the PVR allows the users to provide a preference indication for the individual content items that have been selected. For example, during play back of a recorded television programme a user can simply press a button on a remote control which indicates whether the user likes the current programme or not. The user preference input is in the example provided anonymously. Thus, at least some of the user preferences are not associated with any specific user of the group of users. This has the significant advantage that a very simple operation is sufficient to provide the user input (e.g. a simple press of a button on a remote control) and specifically it is highly advantageous that the individual user does not need to identify him or her self when providing the feedback. However, as a consequence, it is not known which user has provided the individual feedback indication.

The user input processor 103 forwards the user preferences to the cluster processor 105 which stores each user preference together with the characterising data for the content item for which the user preference was provided.

In the example, the PVR thus collects user preferences in the form of programme ratings. The user preferences may be explicit as previously described (e.g. the user rates the programme via dedicated buttons on the remote) or implicit (e.g. the PVR monitors user watching patterns to infer preferences). As an example, each time a content item is selected the user preference for the content item may be increased by a predetermined fixed amount. As the user preferences are anonymous, the user preferences for all users are in effect merged by the PVR.

It will be appreciated that in some embodiments, user preferences are not provided but the further processing is based only on the characterising data for the content items. Thus, step 203 is an optional step.

Step 203 is followed by step 205 wherein the cluster processor 105 clusters the content items into content item clusters in response to characterising data associated with each content item. In the example, the cluster processor 105 only has characterising data, and possibly, user preference data for the content items which have been selected for viewing or recording by the users. Accordingly, only these content items are included in the clustering process.

The clustering is performed using a clustering algorithm such as a K-means clustering algorithm. A clustering algorithm generally attempts to minimize a criterion, such as an error measure, according to a distance function (or similarity measure). It will be appreciated that the clustering may be performed using any suitable such distance function (or similarity measure). Specifically, the clustering may use a function computing the similarity of two programmes as the (weighted) sum of the similarity of their descriptive metadata (e.g. genre, channel, etc.) and/or context information (time of viewing . . . )

$$similarity ( {P}_{1} , {P}_{2} ) = {\sum }_{i ∈ \{ metadata ( P ) \}} {α}_{i} \cdot {similarity}_{i} ( {P}_{i , 1} , {P}_{i , 2} )$$

In the example, the K-means clustering algorithm initially defines k clusters with given initial parameters. The characterising data are then matched to the k clusters. The parameters for each cluster are then recalculated based on the characterising data that have been assigned to each cluster. The algorithm then proceeds to reallocate the characterising data to the k clusters in response to the updated centroid for the clusters. If these operations are iterated a sufficient number of times, the clustering converges resulting in k groups of content items with characterising data having similar properties.

In the specific example, the clustering is also performed in response to the user preferences stored for the content items that are clustered. Indeed, characterising data for a given content item may be considered to comprise both the user preference data received by the user input processor 103 for the content item and the characterising data received from the content data receiver 101. Thus, in the above similarity measure, weighted terms may be included for user preferences as well as metadata (in other words, the parameters P_{i,1} and P_{i,2} may be both user preference data and metadata).

Following the clustering of step 205, the method proceeds in step 207 wherein the cluster data processor 107 determines cluster characterising data for each of the content item clusters generated by the clustering in step 207. The cluster characterising data for a given cluster is determined in response to the characterising data associated with the content items in the given content item cluster.

Thus, in step 207 a cluster characterising data providing a description of each cluster is computed. This description could take various forms, from e.g. a list of the most represented genres or the most significant keywords, to the complete list of programmes. The cluster characterising data can specifically include average metadata for the content items and/or metadata which is present in more than a given proportion of the content items in the specific content item cluster.

In the specific example where a k-means clustering algorithm is used, the cluster characterising data may be generated as part of the clustering algorithm. Specifically, for a given cluster, the cluster data processor 107 may set the characterising data to be equal to the final cluster centroid that was used to determine the similarity between the content items and the clusters.

In some examples, the cluster characterising data may furthermore be determined in response to the user preferences associated with the content items in a given content item cluster. Specifically, the cluster characterising data may include one or more user preference indications associated with the content item cluster as a whole.

It will be appreciated that steps 201 to 207 may be performed once but are typically repeated at regular intervals. Specifically, new content item characterising data and user preference data is provided to the cluster data processor 107 as and when it is received by the content data receiver 101 and the user input processor 103 respectively. The cluster processor 105 may then repeatedly perform a re-clustering process. The re-clustering may e.g. be performed at regular intervals or when the amount of received data which was not included in the previous clustering operation exceeds a given level.

Thus, in the specific embodiment, the cluster data processor 107 will always have cluster characterising data which is fairly up to date.

The following will describe the processing performed when a new content item is received (or characterising data therefor is received) for which a user profile is to be generated. It will be appreciated that any suitable criterion for when to generate a user profile for a content item may be used. For example, user profiles may be generated for all content items, for all content items selected for viewing/recording or for content items manually selected for generation of a user profile.

In step 209, first characterising data is received for a first content item for which a user profile is to be generated. In the specific example, the first content item is a television programme. It will be appreciated that the first characterising data may be received together with the content item itself or may be received independently. For example, the first characterising data may be received as part of the EPG in advance of the transmission of the television programme.

Step 209 is followed by step 211 wherein the first characterising data is fed to the cluster selection processor 109 which proceeds to select a first content item cluster in response to a comparison of the first characterising data and the cluster characterising data of each content item cluster.

Specifically, the cluster selection processor 109 proceeds to compare the first characterising data to the cluster characterising data of all the clusters. The cluster which results in the highest similarity measure is then selected as the first content item cluster.

In the specific example, the same similarity measure is used for the clustering and for the comparison of the first characterising data and the cluster characterising data. Thus, the equation provided previously may be used to select the first content item cluster which accordingly will be the cluster that is considered to most closely resemble the first content item (and the cluster in which the first content item would be grouped if it was included in the clustering approach). Hence, the selection associates the first content item with first cluster characterising data for closely related content items. Thus, it is highly likely that the information of the first cluster characterising data will also apply to the first content item and indeed to the user who has selected the first content item.

Step 211 is followed by step 213 wherein the user profile processor 111 generates a user profile for the first content item in response to the first cluster characterising data.

Specifically the user profile may be selected to include all or part of the characterising data. E.g. the user preference data of the first cluster characterising data may be considered to also apply to the first content item since this is very similar to the content items of the first cluster. Also, other characterising data may be included in the user profile to more accurately describe the likely characteristics of the user.

As a specific example, the first content item may be a general sports programme including a number of different sports. The cluster selection processor 109 may identify that the first content item is closely related to a sports cluster which comprises a number of sports programmes. The cluster characterising data for the sports cluster may indicate that a very high proportion of the programmes in this cluster involve motor sports and football, that the programmes tend to be viewed after 9 PM etc. In response, the user profile processor 111 may determine that the user who has selected the general sports programme is likely to watch it after 9 PM and is likely to be mostly interested in the motor sports and football elements of the programme.

Furthermore, the described approach not only provides additional information for a given content item but also allows a user profile to be likely to represent the specific preferences of a specific user or subset of users of the group of users that use the PVR. This customisation or adaptation to the individual user is completely automatic and does not require any user identification of the users during the user preference provision phase or the user profile generation phase.

For example, over time user preferences for a large number of content items may be provided. Following clustering, the content items are divided into clusters of a suitable size. For example, the clustering may result in a sports programme cluster, a children's programme cluster, a news programme cluster, a film cluster etc. For each of these clusters, user preferences will typically be provided by the user (users) having an interest in the category of programmes to which the cluster relates. For example, a male adult may have particular interest in sports programmes, a female adult a specific interest in news programmes, both may have an interest in films and a child may only have an interest in children's programmes. Accordingly, the data for the sports cluster will predominantly reflect the characteristics of the male adult, the data for the news cluster will predominantly reflect the characteristics of the female adult, the data for the film cluster will predominantly reflect the characteristics of the combination of the male and female adult and the data for the children's cluster will predominantly reflect the characteristics of the child. Thus the clustering has not only grouped similar programmes but also managed to separate preferences for the individual users (or subsets of users) without any identification of any user being provided. As a content item is received and matched to a specific cluster, the data for this cluster is applied to the content item thereby resulting in a user profile which reflects the individual user (or subset of users) with an interest therein. As the content item is likely to be selected by this user (or subset of users) the user profile is likely to reflect the profile of this individual user rather than the whole user group. Thus, a customised or targeted user profile is automatically generated based on anonymous selection of the content item and anonymous user preference inputs.

In the example, the described approach is used to provide targeted adverts to the individual user. Accordingly, step 213 is followed by step 215 wherein a suitable advert is selected for the first content item.

Thus, the user profile is fed to the content combine processor 113 which proceeds to access the content item store 115 to select a suitable associated content item which in the example is an advert. Specifically, the content item store 115 has a number of adverts stored locally (these may e.g. be simple logos or text that is superimposed on the television image or may be full multimedia adverts replacing the multimedia stream of the television programme). In addition, characterising data is stored for the adverts. This characterising data may e.g. include data indicating likely preferences of users for which the advert is particularly suitable.

As a specific example, the content item store 115 can contain an advert for motor oil, another for tennis rackets, another for football boots, another for skis etc. The characterising data may indicate the sport associated with the advert (e.g. motor sport, tennis, football, ski etc). Accordingly, the content combine processor 113 selects the advert for which the characterising data most closely matches the user profile (e.g. a measure similar to the one described for the clustering algorithm may be used). In the previous example of a general sports programme, the content combine processor 113 can thus select the motor oil and football boot adverts over the tennis racket and ski adverts even though these sports may also be included in the specific programme.

The content combine processor 113 then retrieves the selected advert and includes it in the television programme when this is presented to the user (or it may e.g. include it when the programme is recorded). As a specific example, the content combine processor 113 may be arranged to overlay the television image with e.g. a logo for the motor oil company and or may completely replace the received television signal with locally stored adverts during dedicated advertisement sections.

The combined presentation content item is then fed to a user presentation controller 117 which can present the presentation content item to the user (including storing the programme for later play back).

It will be appreciated that in other examples, other associated content items than adverts may be combined with the first content item. For example, additional information related to specific scientific disciplines of particular interest to the user may be added to general science programmes.

The described system thus provides a simple mechanism that allows e.g. advertisers to better target adverts to the individual viewers yet is suitable for multi-user devices and provides ease of use for such devices.

The system enables a better targeting of adverts by providing more information about the individual user's tastes without requiring any action from the user. It is well suited to the specific usage patterns of home television. In addition, if several users have similar preferences, the system will naturally target adverts for groups as the selected cluster will be a cluster representing the group of users with interest in the cluster.

This system may furthermore be implemented in ways that do not compromise the user's privacy. If the selection of the associated content item is performed locally, no personal information is communicated to other entities. Also, even if additional information is provided e.g. to an advertiser, this information is not explicitly associated with an individual since the preferences are provided anonymously. Indeed, such information may correspond to several family members who share similar tastes.

In the example, the adverts were locally stored and selected by the PVR itself. However, in other embodiments the user profile may be transmitted to a remote server which may select the associated content item. For example, the user profile may be transmitted to an advertiser or content provider. For example, the PVR may be connected to the Internet and be arranged to transmit the user profile to a server operated by a content provider/advertiser also connected to the Internet. When receiving the user profile, the remote server may proceed to select the appropriate advert(s) similarly to the approach used by the content combine processor 113. Thus, descriptive information about the closest cluster may be made available to an advertiser thereby providing the advertiser with more information about the preferences and characteristics of the current viewer(s).

In some embodiments, the first characterising data is received in advance of the first content item and the user profile is generated before the first content item is received. The PVR may then further proceed to download the associated content item from a remote server in advance of receiving the first content item. This will allow the first content item to be ready for combination with the first content item when this is transmitted to the PVR. The downloading of a specific associated content item may be controlled and/or instigated by the PVR and/or by the remote server.

Specifically, when EPG data is received and a content item is selected for future viewing or recording by a user, the PVR can proceed to generate the user profile and send it to the television provider. When receiving the user profile, the television provider can proceed to select suitable advert(s) and download them to the PVR, e.g. using a different distribution medium than is used for the television programme itself. Thus, in such an example, user profile data may be sent to the television provider before advert slots thereby allowing the provider to send appropriate adverts to the user's set-top box prior to the advert slots.

In some embodiments, the cluster characterising data for the first content item cluster is updated in response to at least one of the first characterising data and a user preference indication for the first content item. Specifically, when the matching first content item cluster has been selected, the characterising data for the first content item cluster may be compared to the cluster characterising data and updated to reflect that the first content item should also be considered as part of the first content item cluster. Similarly, if any user preference input is provided for the first content item, e.g. when this is presented to the user, this user preference data can also be considered as being for a content item being part of the first content item cluster. Specifically, in systems wherein re-clustering is performed at suitable intervals, the first content item can be included in any subsequent re-clustering operations.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controller. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor.

Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of generating a user profile, the method comprising:
receiving characterising data for a plurality of content items, the characterising data describing characteristics of each content item;
clustering the plurality of content items into content item clusters in response to characterising data associated with each content item;
for each content item cluster of the content item clusters determining cluster characterising data in response to characterising data associated with each content item in the content item cluster;
receiving first characterising data for a first content item;
selecting a first content item cluster from the content item clusters in response to a comparison of the first characterising data and the cluster characterising data of each content item cluster;
generating a user profile for the first content item in response to first cluster characterising data of the first content item cluster.

2. The method of claim 1 further comprising the step of receiving user preferences for the plurality of content items, the user preferences being from a plurality of users; and wherein the step of determining cluster characterising data comprises determining the cluster characterising data in response to user preferences associated with each content item in the content item cluster.

3. The method of claim 2 wherein the cluster characterising data for a content item cluster comprises user preference data determined in response to user preferences of content items in the content item cluster; and wherein the user profile for the first content item comprises user preference data determined in response to user preference data of the first cluster characterising data.

4. The method of claim 2 wherein clustering the plurality of content items into content item clusters is further in response to user preferences associated with each content item.

5. The method of claim 2 wherein at least some of the user preferences for the plurality of content items are anonymous.

6. The method of claim 1 further comprising selecting an associated content item for the first content item from a group of content items in response to the user profile.

7. The method of claim 6 further comprising combining at least the first content item and the associated content item to generate a presentation content item and presenting the presentation content item to a user.

8. The method of claim 6 further comprising transmitting the user profile to a remote server and wherein the selecting of the associated content item is performed by the remote server.

9. The method of claim 6 wherein the group of content items is locally stored.

10. The method of claim 6 wherein the first characterising data is received in advance of the first content item and the method further comprises downloading the associated content item from a remote server in advance of receiving the first content item.

11. The method of claim 6 wherein the associated content item is an advert.

12. The method of claim 1 wherein the clustering comprises a clustering of the plurality of content items using a k-means clustering algorithm.

13. The method of claim 1 further comprising updating the cluster characterising data for the first content item cluster in response to at least one of the first characterising data and a user preference indication for the first content item.

14. The method of claim 1 further comprising repeatedly re-clustering the plurality of content items into content item clusters.

15. The method of claim 1 wherein a same similarity measure is used for the clustering and the comparison of the first characterising data and the cluster characterising data.

16. The method of claim 1 wherein the plurality of content items and the first content item are television programmes.

17. An apparatus for generating a user profile, the apparatus comprising a processing system including a memory arranged to store one or more sets of programming instructions that control the processing system to:
receive characterising data for a plurality of content items, the characterising data describing characteristics of each content item;
cluster the plurality of content items into content item clusters in response to characterising data associated with each content item;
for each content item cluster of the content item clusters determine cluster characterising data in response to characterising data associated with each content item in the content item cluster;
receive first characterising data for a first content item;
select a first content item cluster from the content item clusters in response to a comparison of the first characterising data and the cluster characterising data of each content item cluster;
generate a user profile for the first content item in response to first cluster characterising data of the first content item cluster.

18. A media arranged to store programming instructions that control a processing system to:
receive characterising data for a plurality of content items, the characterising data describing characteristics of each content item;
cluster the plurality of content items into content item clusters in response to characterising data associated with each content item;
for each content item cluster of the content item clusters determine cluster characterising data in response to characterising data associated with each content item in the content item cluster;
receive first characterising data for a first content item;
select a first content item cluster from the content item clusters in response to a comparison of the first characterising data and the cluster characterising data of each content item cluster;
generate a user profile for the first content item in response to first cluster characterising data of the first content item cluster.
